(19) United States
(12) Patent Application Publication
(10) Pub. No.: US 2009/0061971 A1
(43) Pub. Date: Mar. 5, 2009

(54) Object Tracking Interface Device for Computers and Gaming Consoles

(75) Inventors: Daniel Weitzner, Concord (CA); Peter Muellerchen, Concord (CA); Martin Monestier, Concord (CA)

Correspondence Address: DENNISON ASSOCIATES, 133 RICHMOND STREET WEST, SUITE 301, TORONTO, ON, M5H 2L7, CA

(73) Assignee: VISUAL SPORTS SYSTEMS, Concord (CA)

(21) Appl. No.: 11/848,956

(22) Filed: Aug. 31, 2007

(51) Int. Cl. G06K 9/00; A63F 9/24

(52) U.S. Cl. 463/2; 382/103

(57) ABSTRACT

The present invention is directed to an object tracking interface device for use with computers and game consoles. The object tracking interface device tracks the movement of a moving object within the field of view of the object tracking interface device and provides input to the computer or game console on the movement of the moving object. The object tracking interface device comprises one or more detection means which view a viewed space through which the moving object moves, a means for receiving the output of the detection means for determining the presence of a moving object, a means calculating one or more parameters of the movement of the moving object, and a means for converting the parameters of the movement of the moving object into a signal which can be input into the computer or gaming console. The present invention also provides an apparatus for a sports simulation game for playing of sports utilizing a moving object, the game comprising a display screen, a object tracking interface device for tracking the movement of the moving object within the field of view of the object tracking interface, a projector for displaying the sports simulation game on the screen and a computer or game console for operation the sports simulation game. The object tracking interface device includes at least one detection means mounted at each of the top corners of the screen to provide a field of view of the detection means to cover the space in front of the screen. The object tracking interface device also includes a means for receiving the output of the detection means for determining the presence of a moving object, a means for calculating one or more parameters of the movement of the moving object and a means for converting the parameters of the movement of the moving object into a signal which can be input into the computer or gaming console.

### FIELD OF THE INVENTION

The present invention is directed to an object tracking interface device for use with computers and game consoles. In particular, the present invention is directed to an object tracking interface device which tracks the movement of a moving object within the field of view of the object tracking interface device and which provides input to the computer or game console on the movement of the moving object.

### BACKGROUND OF THE INVENTION

Video games for playing on a personal computer or game console have become quite popular. A very popular type of video game is a sports simulation game simulating a sport such as golf, hockey, football, baseball, etc. These games are generally played by the user using an interface device to interact with the video game console or computer.

A number of such user interface devices which allow a user to interact with video games and computers are known. Common examples of such interface devices include a mouse, a joystick, a keyboard, etc. These interface devices use a communication protocol to interact with the computer or game console generally through a serial communication. The most commonly utilized communication protocol is a universal serial bus (USB) created by the Universal Serial Bus Implementation Forum Inc. (USB-IF). The USB standard defines several device classes for peripherals, including the Human Interface Device (HID) class which includes keyboards, mouse, joysticks, track ball, etc., and allows the interface device to interact with the computer. Joysticks and a mouse produce output signals which are transmitted to the computer or game console to allow operation of the game. The output's signals correspond to the attitude of the joystick or mouse, which is moved along an X-Y path to control the movement of a display element on the video terminal of the computer or game console. Such interface devices as a mouse or joystick are limited to two dimensional spatial coordinates and cannot easily be used for objects moving in a three dimensional space.

A number of other types of user interface devices have been developed to allow a user to interact with video games and computers. Examples of such user interface devices include a simulated surfboard shown in U.S. Pat. No. 4,817,950, a method of playing racket and other types of games as described in U.S. Pat. No. 4,695,953 and a treadmill-type arrangement as described in U.S. Pat. No. 4,278,095. In addition, Published U.S. Patent Application No. 20070049374 by Nintendo describes a game system which utilizes a game controller having a motion detection capability. These other user interface devices have been developed to provide for a more realistic gaming experience when a user is playing games and in particular, sports simulation games. However, these user interface devices do not completely mimic the experiences the user would encounter if playing the real game particularly in a three dimensional spatial relationship.

U.S. Pat. No. 5,333,874 to Arnold describes a sports simulator in which a user can launch an object such as a golf ball toward a screen through a housing having planes defined by an array of infra red emitters and receivers positioned in the housing. A computer is connected to the infrared receivers which detect the passage of the golf ball through the planes of emitters and receivers. Based upon signals from the receivers, the computer using triangulation techniques determines the parameters of flight of the object and causes an image of the golf ball to be displayed on the screen as it would have appeared traveling away from the golfer had it not encountered the screen.

A number of systems have also been developed for monitoring the swing path of a golf dub head and processing the information of the swing path of the golf club head into a predicted path of a golf ball struck by the golf club head. Examples of such systems are shown in U.S. Pat. Nos. 7,214,138; 5,471,383; 6,042,483 among others.

The use of video cameras for tracking moving objects such as golf balls, baseballs, etc is also known. Examples of such systems are shown in U.S. Pat. Nos. 5,342,051; 5,768,151; 5,938,545, among others.

U.S. Pat. No. 6,430,997 to Trazer Technologies, Inc. describes a sport simulation system which employs sensing electronics for determining the player's three-dimensional changes in a computer controlled sports specific cueing that evokes or prompts sports specific responses from the player to provide an indication of performance. The system also utilizes a virtual opponent that is responsive to and interactive with the player in real time. One type of sensing electronics mentioned is video cameras.

While the prior art describes a number of different user interfaces to more closely resemble an actual sport experience when a user is playing a sport simulation game on a computer or game console, the experience does not duplicate the experience of playing the actual game. There thus remains a need for an interface device for use with computers and game consoles to allow for more realistic gaming experience for the user of the game such that the gaming experience imitates to a large extent the real life experience of playing the actual game.

### SUMMARY OF THE INVENTION

The present invention is directed to an object tracking interface device for use with computers and game consoles. The object tracking interface device tracks the movement of a moving object within the field of view of the interface device and provides input to the computer or game console on the movement of the moving object. The object tracking interface device comprises one or more detection means, which view a viewed space through which the moving object moves and provide an output signal, a means for receiving the output signal of the detection means and for determining the presence of a moving object within the viewed space, a means for calculating one or more parameters of the movement of the moving object, and a means for converting the parameters of the movement of the moving object into a signal which can be input into the computer or gaming console.

In an aspect of the invention, the means for receiving the output of the detection means outputs a signal to the means for calculating one or more parameters of a moving object only when the presence of a moving object is detected.

In another aspect of the invention, the means for determining the presence of a moving object is a digital camera more preferably a video camera.

In another aspect of the invention, the means for calculating the one or more parameters calculates the position and velocity vector of the moving object.

In another aspect of the invention, the means for calculating the one or more parameters calculates the spin of the moving object as well as the position and velocity vector of the moving object.

In another aspect of the invention, the means for converting the parameters of the movement of the moving object converts the parameters of the moving object into a signal mimicking a mouse, joystick or game controller input.

In another aspect of the invention, the means for converting the parameters of the movement of the moving object converts the parameters into a human interface device signal which is passed to the computer or gaming console through a universal serial bus.

In another aspect of the invention, there is provided an apparatus for a sports simulation game for playing of sports utilizing a moving object, the game comprising a display screen, an object tracking interface device for tracking the movement of the moving object within the field of view of the interface device, a projector for displaying the sports simulation game on the screen and a computer or game console for operation of the sports simulation game. The object tracking interface device includes at least one means for determining the presence of a moving object mounted adjacent each of the top corners of the screen to provide a field of view of the means for determining the presence of a moving object to cover the area in front of the screen. The interface device also includes a means for receiving the output of the means for determining the presence of a moving object, a means for calculating one or more parameters of the movement of the moving object and a means for converting the parameters of the movement of the moving object into a signal which can be input into the computer or gaming console.

In an aspect of the invention, in the apparatus for a sports simulation game for playing of sports utilizing a moving object described above, the means for receiving the output of the detection means outputs a signal to the means for calculating one or more parameters of a moving object only when the presence of a moving object is detected.

In another aspect of the invention, in the apparatus for a sports simulation game for playing of sports utilizing a moving object described above, the means for determining the presence of a moving object is camera more preferably a video camera.

In another aspect of the invention, in the apparatus for a sports simulation game for playing of sports utilizing a moving object described above, the means for converting the parameters of the movement of the moving object converts the parameters of the moving object into a signal mimicking a mouse, joystick or game controller input.

In another aspect of the invention, in the apparatus for a sport simulation game for playing of sports utilizing a moving object described above, the means for converting the parameters of the movement of the moving object converts the parameters into a human interface device signal which is passed to the computer or gaming console through a universal serial bus.

In another aspect of the invention, in the apparatus for a sports simulation game for playing of sports utilizing a moving object described above, the object tracking interface device is contained within an enclosure at each of the top corners of the frame, the enclosure containing a video camera detection means, the means for receiving the output data of the video camera, and the means for calculating one or more parameters of the movement of the moving object based upon the output data of the video camera.

### BRIEF DESCRIPTION OF THE DRAWINGS

Preferred embodiments of the present invention are illustrated in the attached drawings in which:

FIG. 1 is a perspective view of a preferred embodiment of an apparatus of the present invention for use as a sport simulation device, in particular for playing a simulated golf game;

FIG. 2 is a perspective view of a preferred embodiment of a video camera detection means of an object tracking interface device of the present invention for use in the apparatus of FIG. 1;

FIG. 3 is a perspective view of the video camera setup tracking the movement of a golf ball;

FIG. 4 is a side elevation view of the video cameras tracking the motion of the golf ball;

FIG. 5 is a front plan view illustrating the tracking of the position of a moving object utilizing the object tracking interface device of FIG. 2;

FIG. 6 is an illustration of the tracking of the movement of the moving object by an individual camera of the object tracking interface device of FIG. 2;

FIG. 7 is an illustration of a preferred embodiment of the object tracking interface device with a computer or game console;

FIG. 8 is a block diagram of the object tracking interface device of the present invention for use with a computer or game console;

FIG. 9 is a flow diagram illustrating the use of the apparatus of the present invention with an interface board to a PC or game console; and

FIG. 10 is a flow diagram illustrating the apparatus of the present invention with a USB interface to a computer or game console.

### DETAILED DESCRIPTION PREFERRED EMBODIMENTS

In one aspect the present invention is directed to an object tracking interface device for use with computers and game consoles. The object tracking interface device tracks the movement of a moving object within the field of view of the interface device and provides input to a computer or game console on the movement of the moving object. The object tracking interface device of the present invention is of particular use with sports simulation games, which utilize a ball or other moving object as part of the game.

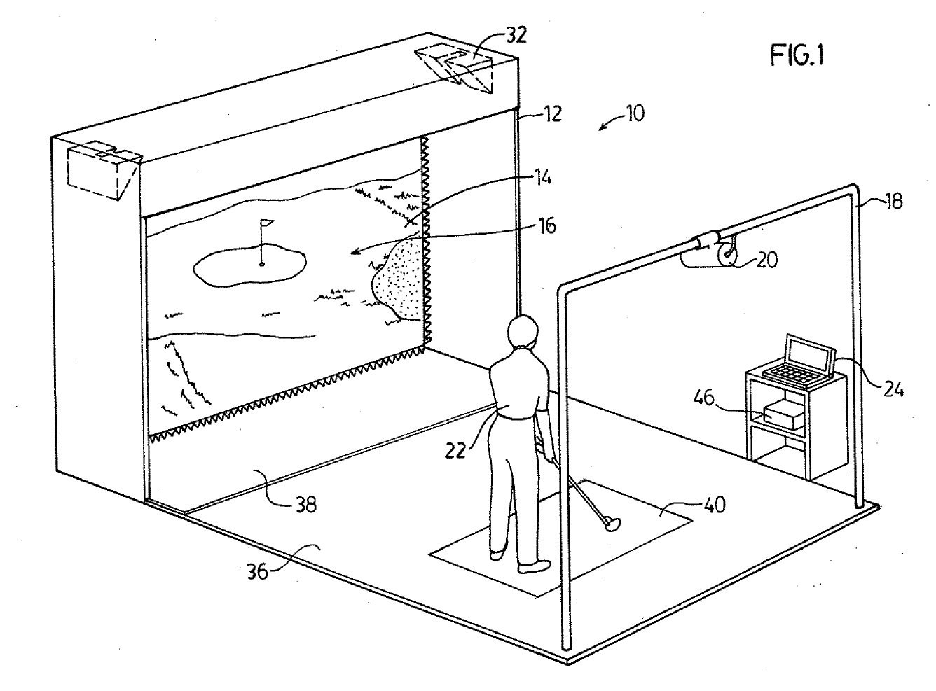

A first preferred embodiment of a sports simulation game utilizing the object tracking interface device of the present invention and in particular an object tracking interface device utilizing digital video cameras as detection means is shown in FIG. 1. The sports simulation game playing apparatus 10 shown in FIG. 1 is for use in playing a game of golf, however as will be explained herein below, other types of games may also be played. The sports simulation game apparatus 10 may include a first frame 12, preferably constructed of tubular members joined together to form a rectangular shaped housing. A screen 14 is provided at the rear of the first frame 12 onto which is projected the image 16 for playing the game. The screen 14 is constructed of a shock absorbing material suitable both for displaying the image as well as for stopping the moving object used in playing the game without being damaged. The apparatus 10 may also include a second frame 18 generally rectangular in shape and having mounted at the top thereof a video projector 20 such that the user 22 of the game does not interfere with the image 16 projected on the screen 14 by the projector 20. The projector 20 is connected to a computer or video game console 24, which contains the program for the game being played including the images 16 to be projected onto the screen 14, as well as receiving the input of the movement of the moving object 26 from the object tracking interface device 28 to allow for playing of the game. In some installations, one or both of the first frame 12 and the second frame 18 may not be required as the screen 14 and/or video projector 20 could be mounted on the ceiling or wall of the space containing the sports simulation playing apparatus 10.

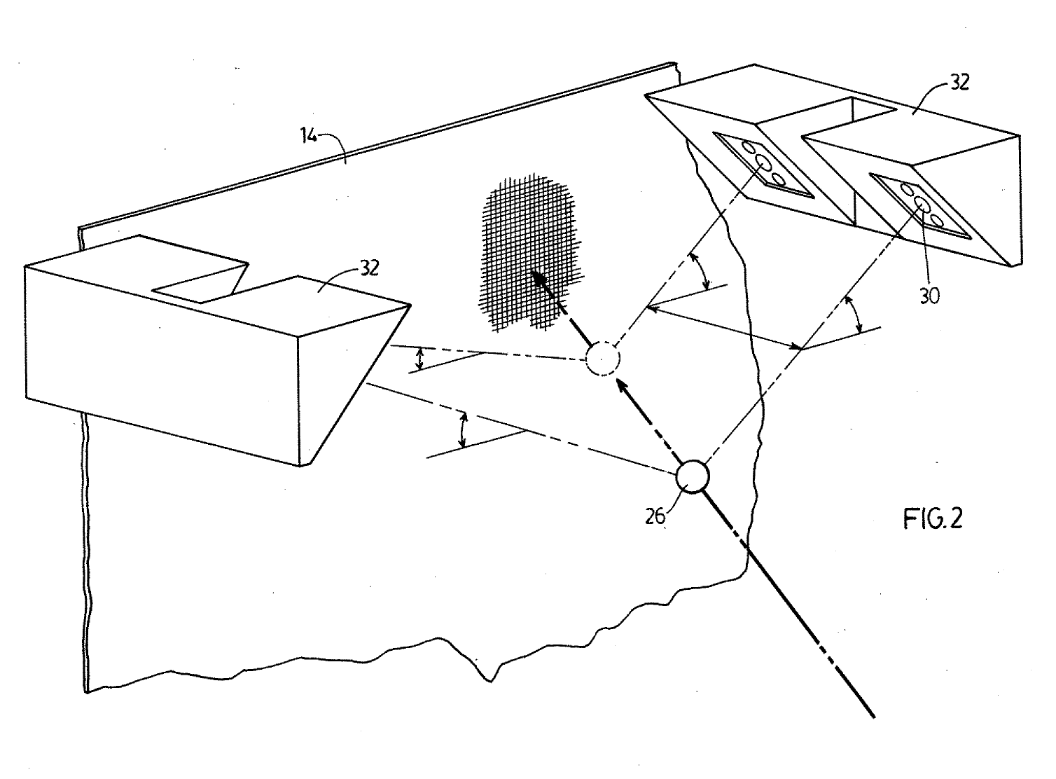

A preferred embodiment of the object tracking interface device 28 includes video cameras 30 mounted adjacent the top corner of the screen 14 more preferably mounted to the first frame 12. As illustrated in FIG. 2, the object tracking interface device 28 of the present invention utilizes a plurality of video cameras 30 to capture the flight of the moving object, such as a golf ball 26, within the field of view of the video cameras 30. The video cameras 30 are mounted at the top corner of the frame 12 preferably pointing downwardly, such that the field of view of each individual camera 30 covers the space in front of the screen 14. More preferably, the video cameras 30 are mounted to view downwardly at a 45° angle. Preferably, in order to enable the video cameras 30 to more accurately track the path and velocity of the moving object such as a golf ball 26, more than one video camera 30 is attached at each side of the frame 12, the individual video cameras 30 being spaced apart a distance to enable the timing of the path of the ball 26 to be properly tracked and calculated.

Each of the video cameras 30 is mounted within an enclosure 32 to be attached to the frame 12. In order to facilitate the setup and installation of the sports simulation game apparatus 10 the enclosure 32 may be adapted to hold more than one video camera 30 for mounting to each side of the frame 12. The enclosure 32 will hold the video cameras 30 utilized at each side of the frame 12 such that the enclosure 32 provides for the proper spacing and orientation of the video cameras 30 for the proper operation of the sports simulation game. Typically to allow for the proper operation of the video interface device 28 of the present invention, the cameras 30 within each enclosure 32 are spaced apart a distance of about 10 to 48 inches, preferably about 10 to 30 inches, more preferably 16 to 24 inches, most preferably about 20 inches.

The sports simulation game apparatus 10 includes a base 36 to which is connected the first frame 12 and second frame 18 in the proper spaced relationship to allow for operation of the game. The base 36 is provided with a mat 38 at the front thereof adjacent the screen 14, the mat 38 being of a colour to provide a proper background to allow the video cameras 30 to observe the moving object 26. Thus, for example, for playing a game of golf, the mat 38 could be black to provide a contrast for the white golf ball. For other games such as hockey where the puck is black, the mat 38 could be selected to be a lighter colour to provide for the contrast. Alternatively, the mat 38 could be a neutral colour to provide contrast with a variety of moving objects. For example, the mat 38 could be green, this providing contrast for both light and dark moving objects.

The base 36 of the sports simulation game is also provided with a playing mat 40 that is adapted to allow for the playing of the selected game. Thus, for playing a game of golf, the playing mat 40 would be a synthetic carpet material imitating a grass mat. The playing mat 40 may be provided with tee locations to allow for teeing of the golf ball 26. By providing the playing mat 40 as a grass-like mat, the player can hit the golf ball 26 directly off of the mat 40 utilizing an iron and a putter. For playing the game of hockey, the mat 40 would be a low friction plastic material to allow the user 22 to shoot the puck from the playing mat 40.

To play a game with the sports simulation game apparatus 10 of the present invention, the suitable game program is started at the computer or game console 24. The player 22 inputs the relevant information into the game, such as a player's name and selects the game options as desired. For example, when playing a game of golf, the player 22 will select the course which he wishes to play, as well as other game options such as handicap etc. The game is then started and the game information displays on the screen 14. To commence play, the player will hit the ball 26 toward the screen 14 when prompted to do so by the game. The object tracking interface device 28 of the present invention detects the ball 26 movement and provides the ball flight information as an input to the computer or game console 24. From the ball flight information provided by the object tracking interface device 28, the game program calculates the distance and direction of the ball flight and displays the ball flight simulation on the screen 14. The player 22 then continues to play the game by striking the ball 26 from the new position, with the desired club and the process is repeated.

The object tracking interface device 28 of the present invention detects the characteristics of the moving object 26 in terms of velocity vector, position and spin and provides these parameters to the computer or game console 24 in a format suitable for use by the game of the computer or game console 24. The object tracking interface device 28 of the present invention includes a means of detecting and tracking a moving object, preferably tracking cameras 30 to track the moving object and output data when a moving object is detected, a means 52 for receiving the output of the cameras 30, a means 54 to calculate the position, velocity vectors and spin of the moving object 26 based upon the data received from the tracking cameras 30 and suitable means 56 to convert the position, velocity vectors and spin of the moving object 26 into a format suitable for use with the computer or game console 24. Preferably, the means 54 to calculate the position and velocity vectors and spin of the moving object based upon the data received from the tracking cameras is provided in hardware or software, more preferably in hardware on a track board 48.

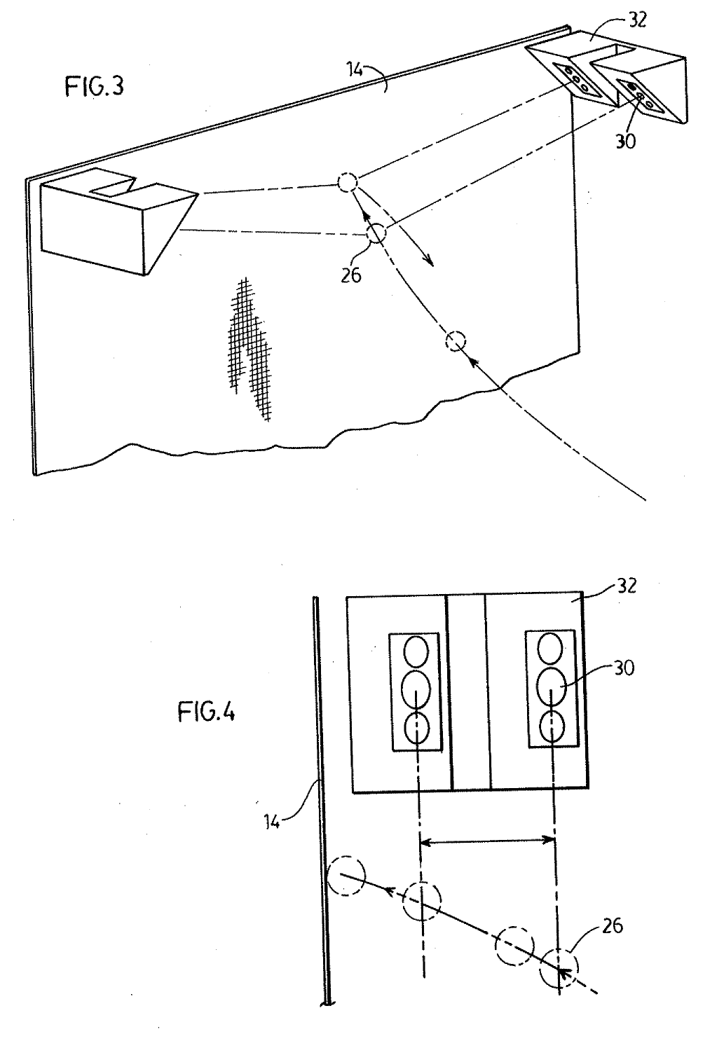

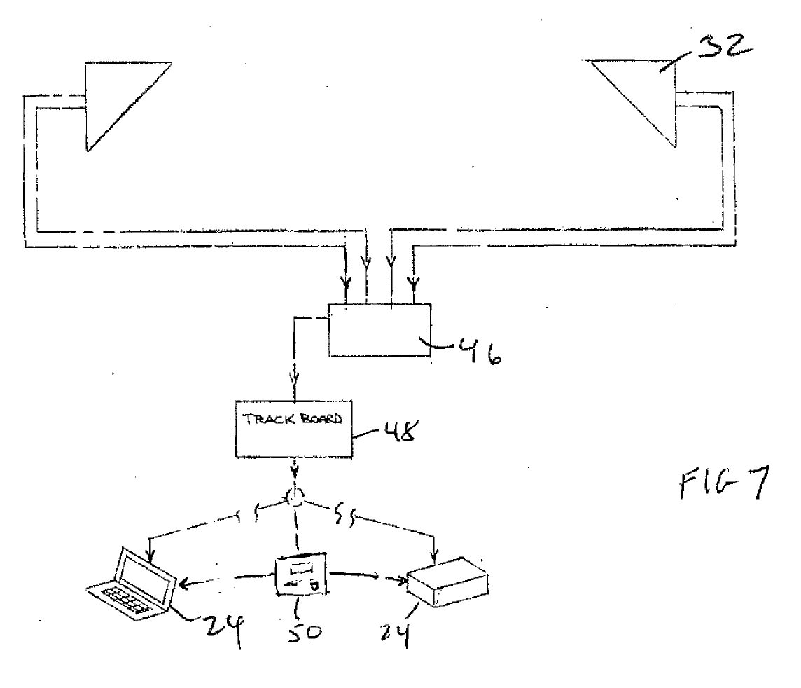

The operation of the video camera 30 in detecting the motion of a moving object 26 will be now described with reference to FIGS. 2 to 6. As shown in the figures, the video interface device 28 of the present invention preferably includes two enclosures 32 at opposing corners of the frame 12 in front of the screen 14. Each of the enclosures 32 is provided with two video cameras 30 spaced apart between 10 and 48 inches. The video cameras 30 are mounted to view downwardly at a 45° angle such that the field of view of each of the video cameras 30 covers the space in front of the screen 14. As shown in FIG. 6, when a moving object 26 passes through the field of view of the video camera 30, an image of the object is focused by the lens 42 of the camera 30 and appears on the pickup device 44 of the video camera 30. As the object 26 moves through the field of view of the camera 30, the image of the object 26 on the pickup device 44 of the video camera 3) also moves. At regular intervals the image on the pickup device 44 on the video camera 30 is passed to a means for receiving the output of the video camera where the output is tested to see if a moving object 26 is detected by comparing successive images from the video camera. The data corresponding to the location on the video camera image 44 of the moving object 26 is transmitted to the means for calculating one or more parameters of the movement of the moving object which further processes the data to enable it to be passed through to the computer or game console.

The video cameras 30 are continuously monitoring the field of view, waiting for the detection of a moving object by detecting a change in the image from one frame to the next. The means 52 for receiving the output of the video camera may accomplish this by storing the image in an image stack and comparing the two most recent entries in the image stack. As each new image is placed in the image stack, the other images are moved downwardly in the stack and the oldest image is discarded. If no change is detected between the two most recent images, the camera 30 continues monitoring the field of view. Alternatively, a base line image for each camera may be established when the object tracking interface device 28 starts up. This base line image is stored in a stack and the subsequent images from the cameras 30 are compared against this base line image to detect changes in the image. When a change in image is detected, the means 52 for receiving the output processes the images and transmits the data of the object detected to a means 54 utilized to calculate the position, velocity vectors and spin of the moving object where the data is further processed as described below.

The means 54 to calculate the one or more parameters of the moving object utilizes triangulation of the data from the images of the video camera to calculate the parameters such as position, velocity vector and spin of the moving object. The means 54 to calculate the parameters is provided with setup information for the object tracking interface device 28 in terms of numbers of cameras, separation distance between the cameras and the sampling rate for the video images of the video cameras. Based upon the setup information and utilizing the data received from the video cameras, the means 54 for calculating the one or more parameters uses a standard triangulation formula to derive the position, velocity vector and spin of the moving object. This information can then be passed through to the means 56 to convert the data of the moving object into a format suitable for use with the computer game console.

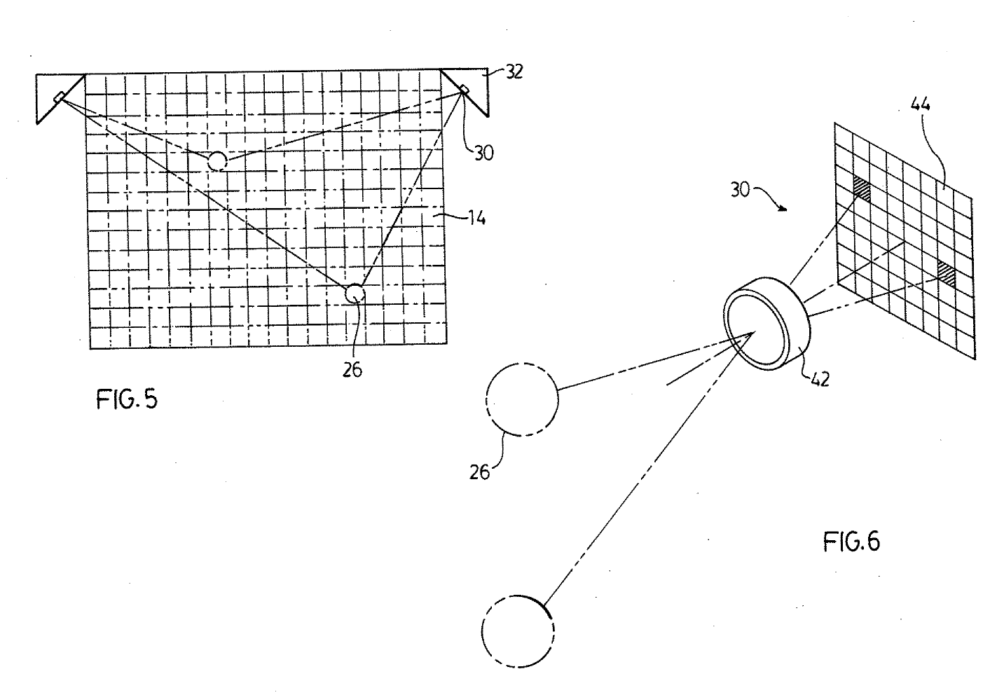

The position of the moving object 26 is determined by the means 52 to receive the output and the means 54 to calculate the one or more parameters of the moving object based upon the position where the object appears on the pickup device 44 of the video camera 30. As shown in FIGS. 5 and 6, the position of the object 26 is determined by combining the position of the object displayed on the image pickup device 44 of each of the individual cameras 30 and utilizing a triangulation formula to place the moving object 26 in the three-dimensional space at the selected point and time of the sampling of the video cameras 30.

The velocity vector of the moving object is determined by comparing the position of the moving object in the three-dimensional space at predetermined time intervals. From the relative positions of the object over at least two time intervals, the velocity and direction of movement of the moving object is determined. From this data, one or more velocity vectors can then be derived.

The spin of the moving object can be determined by relating the change in position of a point on the moving object in relation to the movement of the moving object as the moving object passes through the field of view of the video camera. For example, golf balls are generally provided with a marking or logo. By determining the change in position of the marking or logo in relation to the change in position of the golf bail itself, the spin of the golf ball can be derived which is then passed through to the computer or game console.

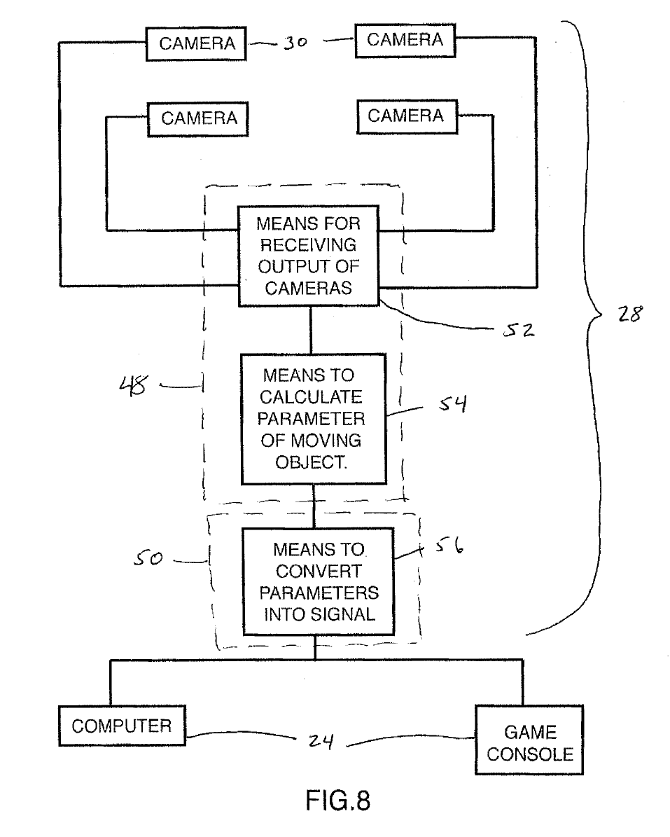

FIGS. 7 and 8 illustrate embodiments of the setup of the object tracking interface device 28 of the present invention with the computer or game console 24 of the present invention. As described above, the object tracking interface device 28 includes the enclosures 32 containing the video cameras 30. Each of the individual video cameras 30 plugs into an interface box 46 which contains the means 52 to receive the output of the video camera, and the means 54 to calculate the one or more parameters of the moving object. Preferably, the means 52 to receive the output of the video cameras 30 and the means 54 to calculate the parameters of the moving object are provided as a translation board 48 in hardware or software. The means 56 to convert the data into a format suitable for use with the computer or game console 24 is provided on a translation board 50 which can be either provided in the interface box 46 or provided as a system board for placement with the computer or game console 24. In the one embodiment, the means 56 to provide the information in a form suitable for use by the computer or game console maps the parameters of the moving object to a sequence of joystick or mouse movement utilizing the translation board 50.

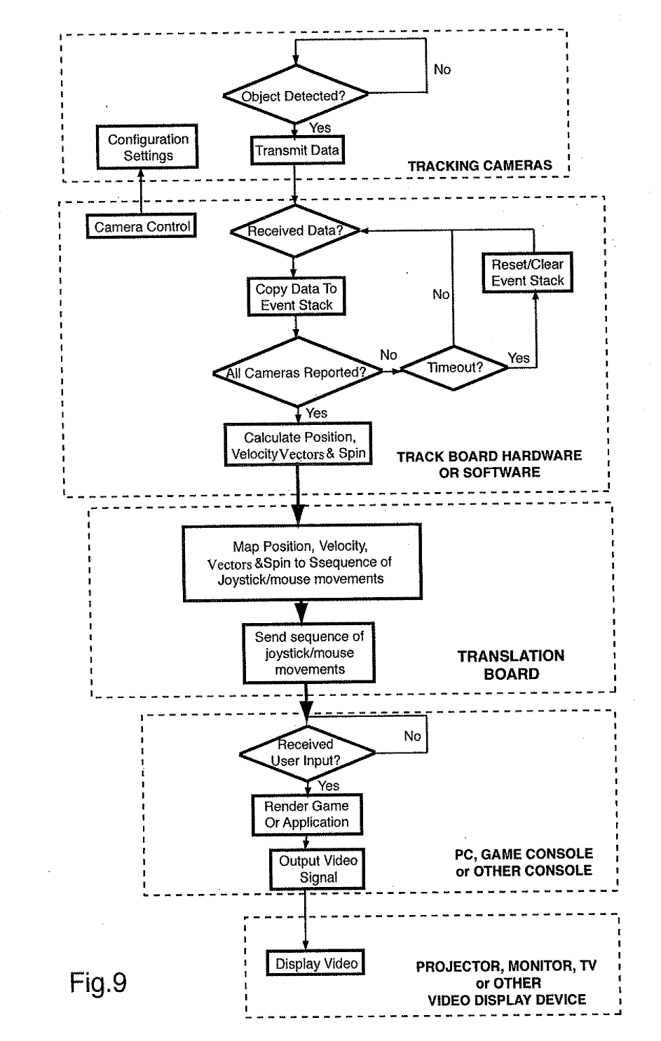

FIG. 9 illustrates a flow chart showing the operation of this embodiment of the object tracking interface device of the present invention. The tracking cameras 30 constantly monitor the field of view and include a means 52 to receive the output of the video camera 30 and to determine a change in image as a moving object comes through the field of view. If no moving object is detected the cameras 30 continue to monitor their field of view. Once a moving object is detected, the tracking camera 30 and means 52 transmits the data of the position of the object to the means 54 to calculate the position, velocity vectors and spin of the moving object on the track board hardware or soft ware. The data received from the cameras 30 by the track board hardware or software is copied to an event stack and once all the cameras have reported, the position, velocity vectors and spin of the object are calculated. If data from one or more of the cameras 30 is missing, the track board hardware or software checks whether there is a timeout and if there is no timeout continues to wait to receive the data from the missing cameras. If the track board hardware or software has detected a timeout then it resets or clears the event stack and commences the operation again. The data of the position, velocity vectors and spin of the moving object are passed to the means 56 to convert the position, velocity vectors and spin of the moving object into a format suitable for use with the PC or game console 24 contained on a translation board, which maps the position velocity vector and spin to a sequence of game controller, joystick or mouse movements suitable for use in the game being played on the computer or game console 24. The translation board then sends the sequence movements to the computer or game console 24 which utilizes the input to render the game or application producing an output video signal, which is sent to the projector 20 for display on the display screen 14.

A further embodiment of the object tracking interface device of the present includes a means for encoding the parameters of the moving object into a standard format for object tracking interface devices which can be connected directly to a USB port of a computer or game console.

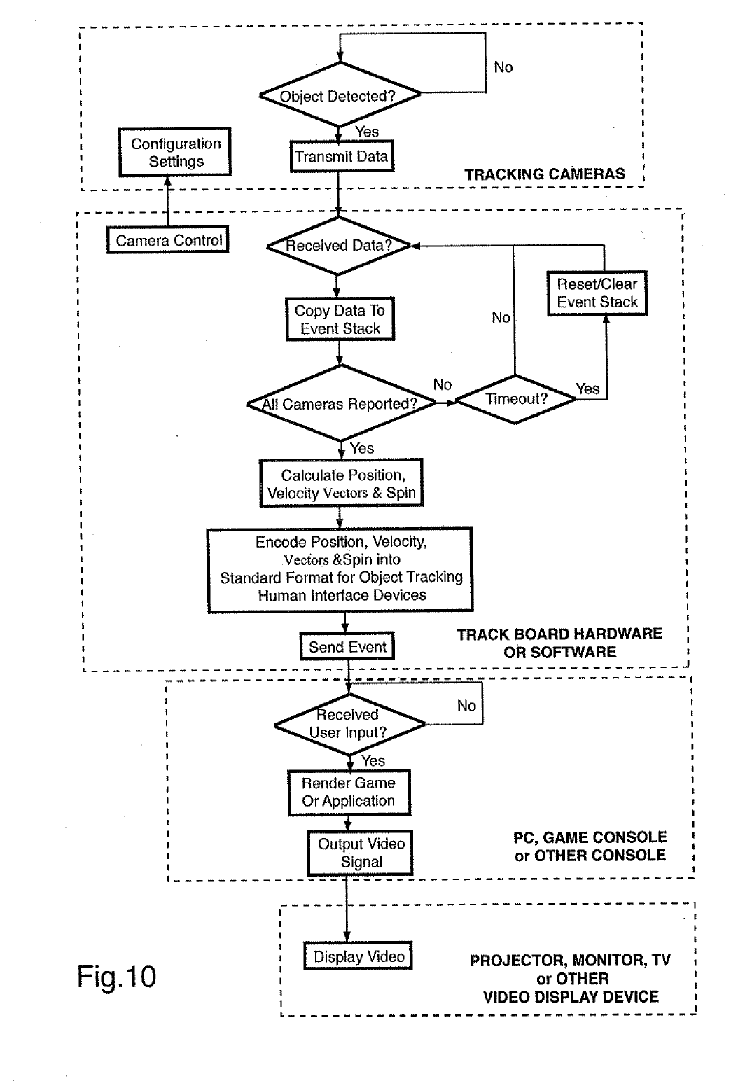

FIG. 10 illustrates a flow chart showing the operation of this further embodiment of the object tracking interface device of the present invention. This embodiment of the object tracking interface device includes a means for encoding the data of the moving object into a standard format for object tracking interface devices utilizing a USB connection. Similar to the first embodiment, the tracking cameras monitor the field of view until an object is detected. Once the moving object is detected the tracking camera transmits the data to position of the object to the track board hardware or software. The data received from the cameras by the track board is copied to an event stack and once all the cameras have reported the position velocity vectors and spin of the moving object are calculated. This calculated data is then converted by a translation board into a standard format, which may then be passed as a standard event to a computer or game console utilizing an object tracking interface device protocol.

The object tracking interface device uses a universal communications protocol to become a peripheral for computers or game consoles. The current standard for communication between most electronic devices is the Universal Serial Bus (USB) created by the Universal Serial Bus Implementers Forum, Inc (USB-IF). The USB standard defines several device classes for common peripherals including the Human Interface Device (HID) class. Within the USB HID class there are usage pages defined for common HID applications, a few examples of usage pages are the simulation control, sports control, and game control pages. Each usage page further defines usage types and applications associated with it. Most operating systems have preinstalled drivers for the classes and usage pages defined by the USB-IF enabling what is commonly referred to as “plug-and-play.” Classes or usage pages that are not defined by the USB-IF generally require custom drivers. In one aspect, the present invention provides the usage types required to create an object tracking interface device driver to utilize the full capability of the device and become plug-and-play.

One method of providing the required usage pages for the object tracking interface device of the present invention will now be described. As the object tracking interface device is a human interface device it should be a member of the USB HID class. The object tracking interface device is a device that measures the 3-Dimensional position, velocity and spin of objects. The Generic Desktop Page is the appropriate usage page for the object tracking interface device since it already contains position and velocity usage types. With a frequency usage type the Generic Desktop page would have usage types for all the parameters measured by the object tracking interface device. The following is an example of a report descriptor for an object tracking interface device.

### Report Descriptor:

| USAGE_PAGE (Generic Desktop) | |
|---|---|
| USAGE (Undefined) | ;Object Tracking Interface Device |
| COLLECTION (Application) | |
| USAGE (Undefined) | ;Velocity Vector |
| COLLECTION (Physical) | |
| USAGE (Vx) | |
| USAGE (Vy) | |
| USAGE (Vz) | |
| UNIT (SI Lin:Vel) | |
| UNIT_EXPONENT (1) | |
| LOGICAL_MINIMUM (−1024) | |
| LOGICAL_MAXIMUM (1023) | |
| PHYSICAL_MINIMUM (−1024) | |
| PHYSICAL_MAXIMUM (1023) | |
| REPORT_SIZE (11) | |
| REPORT_COUNT (3) | |
| INPUT (Data,Var,Abs) | |
| USAGE (Undefined) | |
| LOGICAL_MINIMUM (0) | |
| LOGICAL_MAXIMUM (0) | |
| REPORT_SIZE (7) | |
| REPORT_COUNT (1) | |
| INPUT (Cnst,Var,Abs) | |
| END_COLLECTION | |
| USAGE (Undefined) | ;Spin Vector |
| COLLECTION (Physical) | |
| USAGE (Undefined) | ;Fx (x-axis spin) |
| USAGE (Undefined) | ;Fy (y-axis spin) |
| USAGE (Undefined) | ;Fz (z-axis spin) |
| UNIT (SI Lin:Hertz) | |
| UNIT_EXPONENT (0) | |
| LOGICAL_MINIMUM (−255) | |
| LOGICAL_MAXIMUM (255) | |
| PHYSICAL_MINIMUM (−255) | |
| PHYSICAL_MAXIMUM (255) | |
| REPORT_SIZE (9) | |
| REPORT_COUNT (3) | |
| INPUT (Data,Var,Abs) | |
| USAGE (Undefined) | |
| LOGICAL_MINIMUM (0) | |
| LOGICAL_MAXIMUM (0) | |
| REPORT_SIZE (5) | |
| REPORT_COUNT (1) | |
| INPUT (Cnst,Var,Abs) | |
| END_COLLECTION | |
| USAGE (Undefined) | ;Position (plane 1) |
| UNIT (SI Lin:Distance) | |
| UNIT_EXPONENT (−1) | |
| LOGICAL_MINIMUM (−32767) | |
| LOGICAL_MAXIMUM (32767) | |
| PHYSICAL_MINIMUM (−32767) | |
| PHYSICAL_MAXIMUM (32767) | |
| COLLECTION (Physical) | |
| USAGE (X) | |
| USAGE (Y) | |
| USAGE (Z) | |
| REPORT_SIZE (16) | |
| REPORT_COUNT (3) | |
| INPUT (Data,Var,Abs) | |
| END_COLLECTION | |
| USAGE (Undefined) | ;Position (plane 2) |
| COLLECTION (Physical) | |
| USAGE (X) | |
| USAGE (Y) | |
| USAGE (Z) | |
| REPORT_SIZE (16) | |
| REPORT_COUNT (3) | |
| INPUT (Data,Var,Abs) | |
| END_COLLECTION | |
| USAGE (Undefined) | ;Position (screen) |
| COLLECTION (Physical) | |
| USAGE (X) | |
| USAGE (Y) | |
| USAGE (Z) | |
| REPORT_SIZE (16) | |
| REPORT_COUNT (3) | |
| INPUT (Data,Var,Abs) | |
| END_COLLECTION | |
| USAGE (Pointer) | ; optional (screen) |
| COLLECTION (Physical) | |
| USAGE (X) | |
| USAGE (Y) | |
| LOGICAL_MINIMUM (−128) | |
| LOGICAL_MAXIMUM (127) | |
| REPORT_SIZE (8) | |
| REPORT_COUNT (2) | |
| INPUT (Data,Var,Abs) | |
| END_COLLECTION | ;end of optional pointing device |

END_COLLECTION

The USB HID class requires report descriptors for the operating system to determine the device configuration. Table 1.1 summarizes the report descriptor.

TABLE 1.1
Summary of report descriptor

Bit

| | | | | | | | | |
|---|---|---|---|---|---|---|---|---|
| Byte | 7 | 6 | 5 | 4 | 3 | 2 | 1 | 0 |

| 0 | Vx (decimeters/second) | |
|---|---|---|
| 1 | Vy (decimeters/second) | Vx |

| | | |
|---|---|---|
| 2 | Vz | Vy |

| 3 | Vz (decimeters/second) | |
|---|---|---|
| 4 | Constant | Vz |
| 5 | Fx (Hertz) | |
| 6 | Fy (Hertz) | Fx |

| | | |
|---|---|---|
| 7 | Fz (Hertz) | Fy |

| | | |
|---|---|---|
| 8 | Constant | Fz |

| | |
|---|---|
| 9 | Position - Plane1 X (mm) |
| 10 | |
| 11 | Position - Plane1 Y (mm) |
| 12 | |
| 13 | Position - Plane1 Z (mm) |
| 14 | |
| 15 | Position - Plane2 X (mm) |
| 16 | |
| 17 | Position - Plane2 Y (mm) |
| 18 | |
| 19 | Position - Plane2 Z (mm) |
| 20 | |
| 21 | Position - Screen X (mm) |
| 22 | |
| 23 | Position - Screen Y (mm) |
| 24 | |
| 25 | Position - Screen Z (mm) |
| 26 | |
| 27 | X (optional pointer) |
| 28 | Y (optional pointer) |

There are several “USAGE (Undefined)” entries in the report descriptor. In order to not require a custom driver and to provide play and play support, these sections will be defined in the USB standard for plug-and-play compatibility. In the output description, suggested definitions for the USB standard are provided in the comment beside each instance. There is also an optional section in the report descriptor defining a pointing device allowing the object tracking interface device to act as a touch screen.

The report descriptor displays the general functionality of an object tracking interface device. Sections of the report required for configuration of a specific implementation of an object tracking interface device have been condensed and summarized. The full definition of the HID class and usage tables can be found at http://www.usb.org/developers/devclass_docs/Hut1_{—}12.pdf and http://www.usb.org/developers/devclass_docs/H1D1_{—}11.pdf.

The object tracking interface device of the present invention allows for tracking of moving objects within the field of view of the device so that the parameters of the moving object such as the position, velocity vectors and spin of the moving object, can be passed to a computer or gaming console in a format suitable for use by the computer or gaming console. This object tracking interface device of the present invention is of particular use for playing sports simulation games, which include a moving object, such as a ball as part of the game. For example, the object tracking interface device of the present invention can be utilized for playing a golf simulation game, where the moving object is a golf ball struck by the player of the game. By utilizing the object tracking interface device the present invention the player can play a number of sports simulation games presently available in a more realistic manner. Many of these sports simulation games utilize mouse or joystick motions to imitate the action of striking of the ball. By utilizing the object tracking interface device of the present invention, the player of the game can actually participate in the game by replacing the unrealistic joystick or mouse control with the actual striking of the ball. In this manner not only is the player playing a game in a more realistic manner but the feedback provided by the game also allows for improvement of the player's skills required for playing the game.

In addition to the game of golf, illustrated in the figures, the object tracking interface device of the present invention may also be used for other games, which include a moving object. For example, in baseball games, rather than using the joystick or mouse for deciding upon the type of pitch to be thrown by a pitcher, the player of the game can actually pitch the ball to the representation of a batter displayed on the screen. In this way, the operation of game is more realistic and it also allows for immediate feedback for skill development of the player. Similarly, a hockey game could be played utilizing the object tracking interface device of the present invention where the player would shoot the puck at a goalie, rather than merely utilizing the joystick or other game controller. The use of the object tracking interface device of the present invention with other game types will be apparent to those of skill in the art.

An object tracking interface device of the present invention has been described utilizing cameras, in particular digital video cameras as the detection means for tracking of moving objects within the field of view of the video camera. It will be appreciated by those of skill in the art that other detection means for determining the presence of a moving object may also be utilized within the object tracking interface device of the present invention so long as the detection means outputs data that indicates the position of the object within a three dimensional space at a particular point in time. In this way, the data from the detection means can be utilized by the means for receiving the output of the detection means for determining the presence of a moving object and the means to calculate one or more parameters of the movement of the moving object and converting these parameters into a signal which can be input into the computer or gaming console. For example, other types of detection means which may be utilized to track moving objects for the object tracking interface device of the present invention include radar, infrared detectors and emitters and other sensor arrays, etc. Preferably the detection means to determine the presence of the moving object for use in the object tracking interface system of the present invention is digital cameras and more preferably the digital video cameras as described above. The use of the digital video cameras as described above provides for a versatile, highly configurable, inexpensive solution for tracking and determining the motion of the moving object in a three dimensional space as well as for simulation of the continued movement of the object beyond the monitored space.

The object tracking interface device of the present invention particularly provides for more realistic gaming experience for players of sports simulation games. The object tracking interface device of the present invention provides numerous advantages over the prior art setups, particularly for playing of sports simulation games. The current user interface utilized in such games provides information on two dimensional coordinates using a mouse or joystick or an angular motion, for example, utilizing a wheel. The object tracking interface device of the present invention provides sets of three dimensional coordinates of objects, velocity vectors of the objects, size of the objects, etc. to enable realistic simulation of the motion and action of the object in a sports simulation game. In some situations, the extensive image processing required by the prior art systems slow the game operation and could interface with the gaming experience. A number of current peripheral devices available require extensive image processing and therefore the results with such devices vary from game to game. The object tracking interface device of the present invention provides for preprocessed, standardized info which does not require extensive image processing by the computer or game console and thus saves the computer or game console processing capabilities resulting in a more realistic gaming experience. The object tracking interface device of the present invention is usable with many existing sports simulation games as the object tracking interface device can provide input to the game in the format recognized by the game through the conversion of the data on the moving object into a format recognized by the game. In addition, through the uses of the HID version of the object tracking interface device of the present invention, further capabilities of the object tracking interface device of the present invention can be employed to enhance the player's gaming experience.

The object tracking interface device of the present invention is also usable as a general peripheral device with other applications other than sports simulation games. As the object tracking interface device tracks the motion of a moving object, the object tracking interface device could also be utilized with other applications relating to movement of moving objects. For example, a user could move parts of their body within the monitoring field of view of the video camera and utilize the object tracking interface device of the present invention for practicing activities which require movement such as dance, martial arts, etc. Similarly, the user could use the detected motion to draw images or the display screen e.g. finger painting. Other uses of the object tracking interface device of the present invention will be apparent to those of skill in the art.

Although various preferred embodiments of the present invention have been described herein in detail, it will be appreciated by those of skill in the art that variations may be made thereto without departing from the spirit of the invention or the scope of the appended claims.

We claim:

1. An object tracking interface device for use with computers and game consoles for tracking the movement of a moving object within the field of view of the object tracking interface device and providing input to the computer or game console on the movement of the moving object, the object tracking interface device comprising one or more detection means which view a viewed space through which the moving object moves, a means for receiving the output of the digital means for determining the presence of a moving object and a means to calculating one or more parameters of the movement of the moving object and a means for converting the parameters of the movement of the moving object into a signal which can be input into the computer or gaming console.

2. An object tracking interface device according to claim 1 wherein, the means for calculating the one or more parameters calculates the position and velocity vector of the moving object.

3. An object tracking interface device according to claim 2 wherein, the means for calculating the one or more parameters calculates the spin of the moving object as well as the position and velocity of the moving object.

4. An object tracking interface device according to claim 3 wherein, the means for converting the parameters of the movement of the moving object converts the parameters of the moving object into a signal mimicking a mouse, joystick or game controller input.

5. An object tracking interface device according to claim 3 wherein, the means for converting the parameters of the movement of the moving object converts the parameters into a human interface device signal which is passed to the computer or gaming console through a universal serial bus.

6. An object tracking interface device according to claim 1 wherein, the detection means is a digital camera.

7. An object tracking interface device according to claim 6 wherein, the means for calculating the one or more parameters calculates the position and velocity vector of the moving object.

8. An object tracking interface device according to claim 7 wherein, the means for calculating the one or more parameters calculates the spin of the moving object as well as the position and velocity of the moving object.

9. An object tracking interface device according to claim 8 wherein, the means for converting the parameters of the movement of the moving object converts the parameters of the moving object into a signal mimicking a mouse, joystick or game controller input.

10. An object tracking interface device according to claim 9 wherein, the means for converting the parameters of the movement of the moving object converts the parameters into a human interface device signal which is passed to the computer or gaming console through a universal serial bus.

11. An apparatus for a sports simulation game for playing of sports utilizing a moving object, the apparatus comprising a display screen, an object tracking interface device for tracking the movement of the moving object toward the screen within the field of view of the object tracking interface device, a projector for displaying the sports simulation game on the screen and a computer or game console for operation of the sports simulation game, the object tracking interface device comprising at least one detection means mounted at each of the top corners of the screen to provide a field of view of the detection means to cover the space in front of the screen, a means for receiving the output of the detection means for determining the presence of a moving object, a means for calculating one or more parameters of the movement of the moving object and a means for converting the parameters of the movement of the moving object into a signal for input into the computer or gaming console.

12. An apparatus according to claim 11 wherein, the means for calculating the one or more parameters calculates the position and velocity vector of the moving object.

13. An apparatus according to claim 12 wherein, the means for calculating the one or more parameters calculates the spin of the moving object as well as the position and velocity of the moving object.

14. An apparatus according to claim 13 wherein, the means for converting the parameters of the movement of the moving object converts the parameters of the moving object into a signal mimicking a mouse, joystick or game controller input.

15. An apparatus according to claim 14 wherein, the means for converting the parameters of the movement of the moving object converts the parameters into a human interface device signal which is passed to the computer or gaming console through a universal serial bus.

16. An apparatus according to claim 11 wherein, the detection means is a digital camera.

17. An apparatus according to claim 16 wherein, the means for calculating the one or more parameters calculates the position and velocity vector of the moving object.

18. An apparatus according to claim 17 wherein, the means for calculating the one or more parameters calculates the spin of the moving object as well as the position and velocity of the moving object.

19. An apparatus according to claim 18 wherein, the means for converting the parameters of the movement of the moving object converts the parameters of the moving object into a signal mimicking a mouse, joystick or game controller input.

20. An apparatus according to claim 19 wherein, the means for converting the parameters of the movement of the moving object converts the parameters into a human interface device signal which is passed to the computer or gaming console through a universal serial bus.
